(19) United States
(12) Patent Application Publication
(10) Pub. No.: US 2019/0234384 A1
(43) Pub. Date: Aug. 1, 2019

(54) KINETIC ENERGY GENERATOR SYSTEM

(71) Applicant: Aman Yadav, Arlington, TX (US)

(72) Inventor: Aman Yadav, Arlington, TX (US)

(21) Appl. No.: 16/258,643

(22) Filed: Jan. 27, 2019

Related U.S. Application Data
(60) Provisional application No. 62/622,849, filed on Jan. 27, 2018.

(51) Int. Cl. F03G 3/00; H02K 53/00; F03G 7/10; F03G 7/08

(52) U.S. Cl. CPC F03G 3/00; F03G 7/08; F03G 7/10; H02K 53/00

(57) ABSTRACT

A kinetic energy generator system creates electricity from the effects of gravity and inertia on mass in a series of alternator housing units that rotate about an axis on two spindles. The alternator housing units arrange an alternator, gearbox or other components in order to create electricity from the movement to the mass while the system rotates.

### BACKGROUND

### 1. Field of the Invention

The present invention relates generally to energy production systems, and more specifically, to systems and methods of electricity generation where little or no energy or material is consumed in the process of producing energy.

### 2. Description of Related Art

Energy production systems are well known in the art and are effective means to convert natural resources or phenomenon in to usable power. For example, FIG. 1 depicts a conventional solar power system 101 having a solar panel 103 that captures light 105 from the sun 107. During use, the light 105 captured from the sun 107 is converted by photovoltaic cells to electricity that is transported to and consumed by society.

One of the problems commonly associated with system 101 is its limited use. For example, the solar panels require sunlight to create electricity, when there is no sun the panels are inactive. The panels are also expensive, require direct access to the light and deteriorate over time; these additional limits further reduce the viability of the solar power system to be used to solve the worlds' vast energy demands.

Accordingly, although great strides have been made in the area of energy production systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common solar power system;

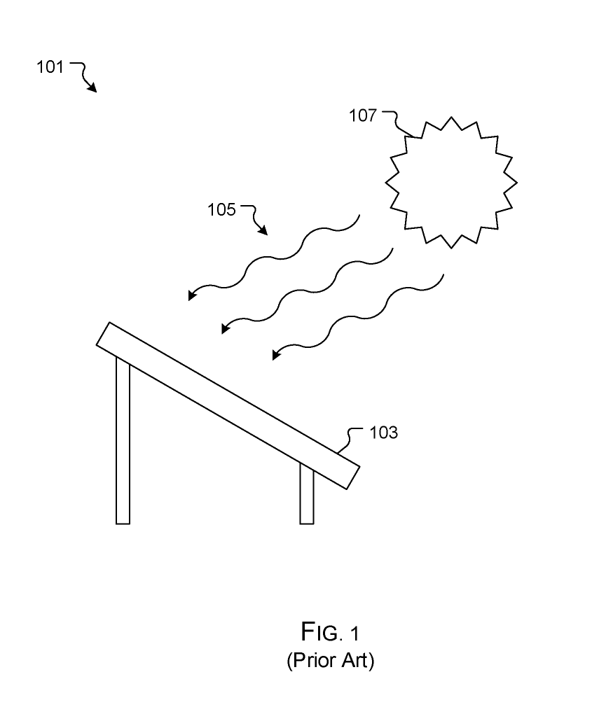

FIG. 2 is a perspective view of a kinetic energy generator system in accordance with a preferred embodiment of the present application;

FIG. 3 is a cross-sectional side view of an alternator housing unit of FIG. 2;

FIG. 4 is a flow chart of the preferred method of use of the system of FIG. 2; and

FIG. 5 is a diagram representing the negligible power needed for the generation of energy.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional energy production systems. Specifically, the invention of the present application is able to create electricity without sunlight or consuming other non-renewable resources. In addition, the cost of the invention is dependent on the output, is scalable and has a long if not infinite lifetime. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

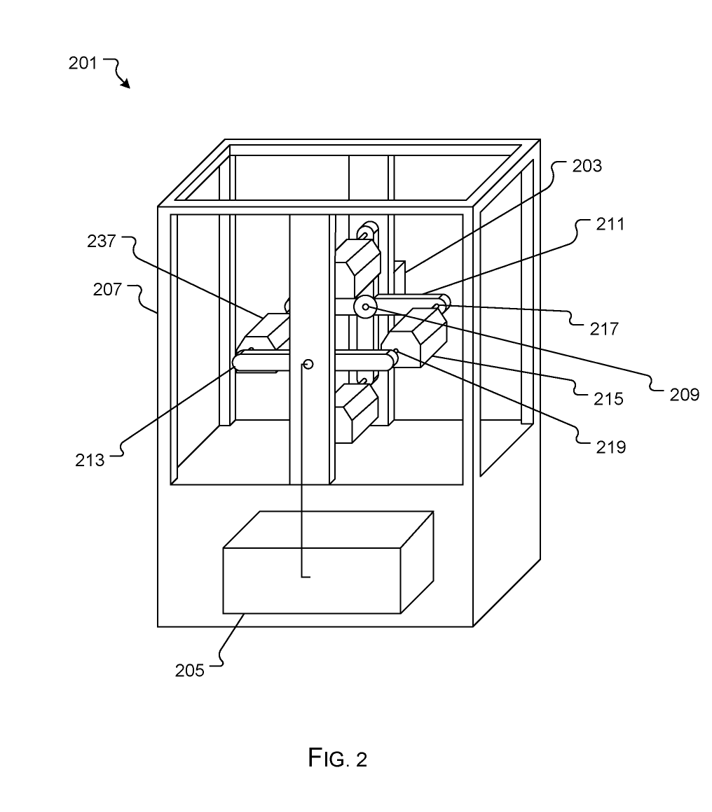

Referring now to the drawings wherein like reference characters identify corresponding or similar elements throughout the several views, FIG. 2 depicts a prospective view of a kinetic energy generator system in accordance with a preferred embodiment of the present application. It will be appreciated that system 201 overcomes one or more of the above-listed problems commonly associated with conventional energy production systems.

In the contemplated embodiment, system 201 includes a motor 203 in electronic communication with a battery 205 or some other power source. The motor 203 being supported by a frame 207. The motor 203 also having an axel 209 that is attached to a first spindle 211. The frame 207 also supporting a second spindle 213.

The first spindle 211 being configured to support alternator housing units 215 via shafts 217. The alternator housing units 215 being configured to rotate freely on the shafts 217.

The second spindle 213 attached to the opposite end of each alternator housing unit 215 via shafts 219 and conveys electricity from the alternator housing units 215 to the battery 205 or some other electricity storage device.

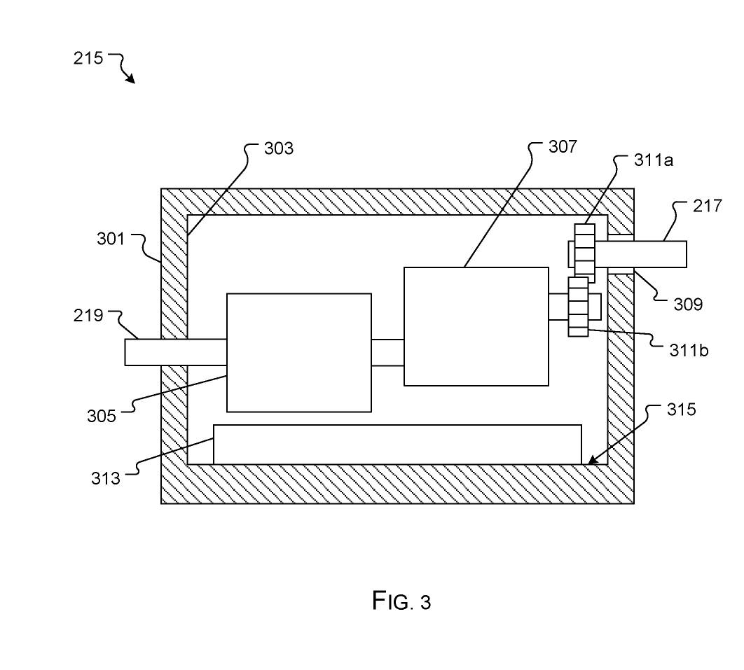

Each alternator housing unit 215, as depicted by FIG. 3, includes a body 301 enclosing an inner space 303 where an alternator 305 and gearbox 307 are housed. The shaft 217 of the first spindle 211 enters the body 301 via an opening 309 and mechanically attaches to the input of the gearbox 307 via gears 311. The output of the gearbox 307 is coupled to the input of the alternator 305 so that the rotational energy from the first spindle 211 is transferred at some magnitude to the alternator 305. The output of the alternator 305 is attached to the shaft 219 of the second spindle 213. The body 301 also having mass 313 attached along the bottom surface 315 of the inner space 303. It is contemplated that the mass 313 can be altered to increase the energy output of the system.

In use, a small quantity of the electricity from the battery 205 is used to activate motor 203 causing the first spindle 211 to rotate about the motors' axel 209. As the first spindle 211 rotates the alternator housing units 215 also rotate so that gravity and inertia are able to cause continually rotation via the mass 313 of the alternator housing units 215. The electricity created by the alternator housing units 215 is stored in the battery.

It should be appreciated that one of the unique features believed characteristic of the present application is that the system is relatively easy to reproduce and at a low cost enabling energy in vast amounts to be produced by individuals without the need to transport the electricity or consume natural resources.

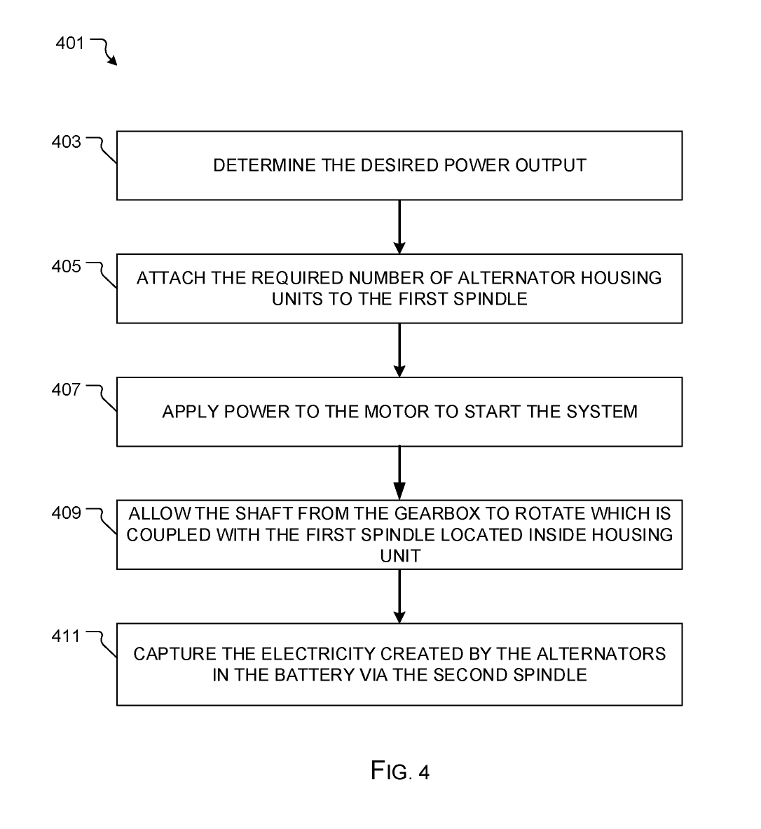

Referring now to FIG. 4 the preferred method of use of the system 201 is depicted. Method 401 including determining the desired power output 403, attaching the required number of alternator housing units to the first spindle 405, applying power to the motor to start the system 407, allowing the shaft from the gearbox to rotate, which is coupled with the first spindle located inside the housing unit, thereby creating and capturing the electricity created by the alternators in the battery via the second spindle 411.

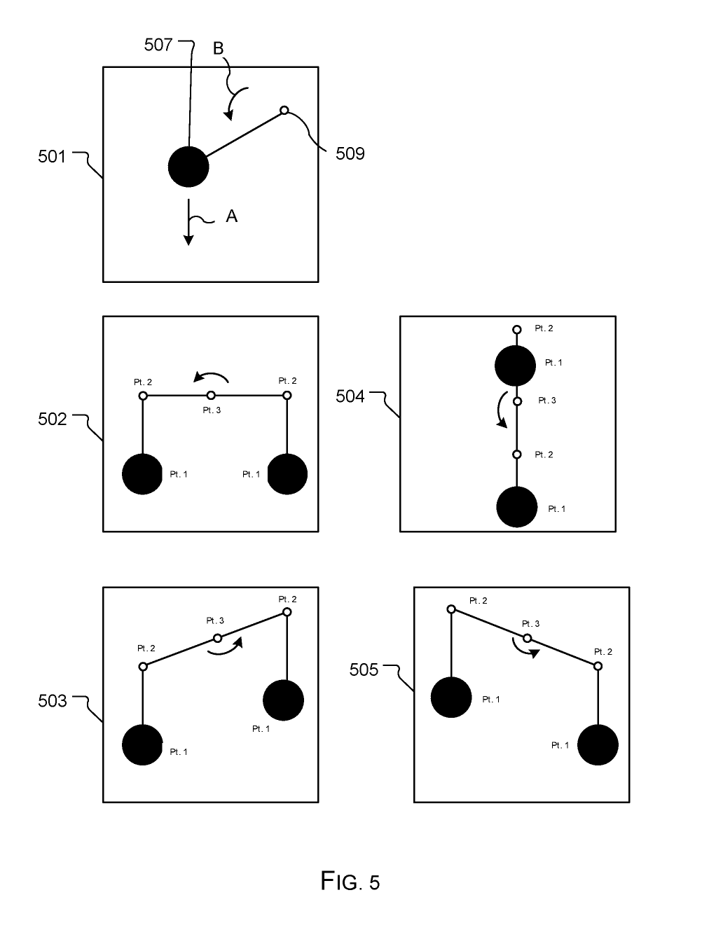

In FIG. 5, a plurality of boxes 501-505 depict the effect of gravity on system 201 for further clarity. It should be appreciated that the principle behind system 201 is kinetic advantage through torque and gravity of an unbalanced body after a round or loop of each housing. As shown in box 501, gravity (A) pulls body 507, which creates torque (B) about pivot point 509. It should be appreciated that no energy is required for rotation due to the gravitational pull on the unbalanced weights.

As shown in boxes 502-505, wherein Pt.1 represents the alternator housing unit and dead weights, Pt.2 represents the shaft of the alternator coupled with spindles outside shaft through gears and gearbox, and Pt.3 represents the motor connected to the center shaft of the spindle. It can be seen that there is no need for energy or torque for rotation at Pt.3 due to the balanced weights on both sides, but there still exists rotational torque at point 2 due to unbalanced weight.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A kinetic energy generator system comprising:
a motor is rotational communication with a first spindle via an axel and frame;
the first spindle having shafts extending outward;
a second spindle rotationally attached to the frame and in electronic communication with an energy storage means; and
the second spindle having shafts extending outward;
a plurality of alternator housing units attached on one end to shafts of the first spindle and to the shafts of the second spindle on the opposite end;
wherein the shafts are free to rotate as coupled to a gearbox by the first spindle; and
wherein the alternator housing units create electricity derived from gravity or inertia as they rotate.

2. An alternator housing unit of claim 1 comprising;
a body enclosing an inner space where an alternator and the gearbox are housed;
the body having mass attached to the bottom surface of the inner space;
wherein the alternator and gearbox are configured to transfer rotational energy input to the alternator housing unit through the gearbox to the alternator where it is converted to electricity and transferred out of the alternator housing units.

3. The method of producing energy given the system of claim 1;
determining the desired power output;
attaching the required number of alternator housing units to the first spindle;
applying power to the motor to start the system;
allowing the alternator housing units to rotate about on their shafts; and
capturing the electricity created by the alternators in the battery via the second spindle.
